(19) United States
(12) Patent Application Publication
(10) Pub. No.: US 2023/0316183 A1
(43) Pub. Date: Oct. 5, 2023

(54) METHOD AND APPARATUS FOR MANAGING SPACE OF A PHYSICAL OFFICE AND A VIRTUAL OFFICE

(71) Applicant: HYUNDAI AUTOEVER CORP., Seoul (KR)

(72) Inventors: Yun Ha Choi, Seoul (KR); Jae Woon Song, Seoul (KR); Eun Jeong Lim, Seoul (KR); Seo Hee Hahn, Seoul (KR); Joung Mi Ahn, Seoul (KR); Choong Il Jeong, Seoul (KR); Seong Hwan Hong, Seoul (KR)

(73) Assignee: HYUNDAI AUTOEVER CORP., Seoul (KR)

(21) Appl. No.: 18/113,412

(22) Filed: Feb. 23, 2023

(30) Foreign Application Priority Data
Mar. 15, 2022 (KR) 10-2022-0032386

(51) Int. Cl. G06Q 10/0631

(52) U.S. Cl. CPC G06Q 10/06313

(57) ABSTRACT

A method for managing space of a physical office and a virtual office includes acquiring work activity data of one or more employees, determining an optimal office layout using the work activity data, evaluating a difference between the optimal office layout and a current office layout, and generating an office reorganization suggestion based on the evaluated difference.

### CROSS-REFERENCE TO RELATED APPLICATION

This application claims the benefit of and priority to Korean Patent Application No. 10-2022-0032386 filed on Mar. 15, 2022, the entire contents of which are incorporated herein by reference.

### FIELD OF THE TECHNOLOGY

Embodiments of the present disclosure relate to a method and an apparatus for managing space of a physical office and a virtual office. More particularly, the present disclosure relates to a method for managing a layout of a physical office or a layout of a virtual office by using various data generated from a work portal and an apparatus for performing the method.

### BACKGROUND

Work spaces, such as offices, are sometimes managed using digital technology. For example, reservations for conference rooms, reservations for visitors, reservations for autonomous seats, reservations for employee cafeterias, requests for office environment adjustment, and the like may be processed using terminals of employees. Further, the employees may conduct work by using various work tools such as ERP, work mail, and in-house messenger. As work has become more computerized, telecommuting has become more commonplace.

However, in terms of optimizing a physical office space, data generated by computerization of work has not been sufficiently considered. Technology for optimizing a virtual office space, which has recently been experimentally introduced, has also not been provided.

### SUMMARY

An aspect of the present disclosure provides a method for determining a layout of a physical office by using work activity data of one or more employees, and an apparatus for performing the method.

Another aspect of the present disclosure provides a method for determining a layout of a virtual office by using work activity data of one or more employees, and an apparatus for performing the method.

Another aspect of the present disclosure provides a method for generating a reorganization suggestion for a layout of a physical office by using work activity data of one or more employees and an apparatus for performing the method.

Another aspect of the present disclosure provides a method for generating a reorganization suggestion for a layout of a virtual office by using work activity data of one or more employees and an apparatus for performing the method.

Another aspect of the present disclosure provides a method for updating a layout of a virtual office by using work activity data of one or more employees, and an apparatus for performing the method.

Another aspect of the present disclosure provides a method for updating a layout of a virtual office by analyzing a movement path in a virtual office, and an apparatus for performing the method.

Another aspect of the present disclosure provides a method for performing a predetermined process to promote use of a virtual office to resolve a congestion situation when the congestion situation occurs in a physical office, and an apparatus for performing the method.

However, aspects of the present disclosure are not limited to those set forth herein. The above and other aspects of the present disclosure should become more apparent to one of ordinary skill in the art to which the present disclosure pertains by referencing the detailed description of the present disclosure given below and the accompanying drawings.

According to an embodiment of the present disclosure, a computer-implemented method for managing space of a physical office and a virtual office comprises acquiring work activity data of one or more employees, determining an optimal office layout using the work activity data, evaluating a difference between the optimal office layout and a current office layout and generating an office reorganization suggestion based on the evaluated difference.

In some aspects, determining the optimal office layout may include determining a work type of each employee, among the one or more employees, using the work activity data, and determining an optimal ratio for each property of office resources using the number of employees for each work type.

In some aspects, generating the office reorganization suggestion may include determining whether to generate the office reorganization suggestion using a magnitude of the evaluated difference and fluctuation of the work activity data.

In some aspects, the optimal office layout and the current office layout may be for the virtual office.

According to another embodiment of the present disclosure, a computer-implemented method for managing space of a physical office and a virtual office comprises acquiring work activity data of one or more employees, and determining an optimal layout of a virtual office using the work activity data.

In some aspects, the work activity data may comprise physical office resource utilization data and work tool use data.

In some aspects, determining the layout of the virtual office may include determining a quantity of each resource disposed in the virtual office using the physical office resource utilization data, and determining properties of each resource disposed in the virtual office using the work tool use data.

In some aspects, determining the properties of each resource disposed in the virtual office may include determining a work type for each employee, among the one or more employees, using the work tool use data of each employee, aggregating the number of employees for each work type, and determining the properties of each resource using a result of the aggregation.

In some aspects, determining the properties of each resource using the result of the aggregation may include determining an object to be added-on to each resource using the result of the aggregation.

In some aspects, the work activity data may further comprise activity data of the employee in the virtual office.

In some aspects, determining the layout of the virtual office may include updating a current virtual office layout with the determined layout.

In some aspects, updating the current virtual office layout with the determined layout may include updating a layout for a public space among the determined layouts with a first cycle, and updating a layout for a personal space among the determined layouts with a second cycle longer than the first cycle.

In some aspects, updating the current virtual office layout with the determined layout may include updating a layout for a public space among the determined layouts in response to occurrence of a predetermined event, and updating a layout for a personal space among the determined layouts with a second cycle.

In some aspects, determining the layout of the virtual office may include acquiring a layout of a physical office corresponding to the virtual office, and adjusting the acquired layout of the physical office using the work activity data to determine the adjusted layout of the physical office as the layout of the virtual office.

According to yet another embodiment of the present disclosure, a computer-implemented method for managing space of a physical office and a virtual office comprises acquiring movement path data in the virtual office, and performing an update on a layout of the virtual office using the movement path data.

In some aspects, performing the update on the layout of the virtual office may include performing an update on a movement means from a first space to a second space inside the virtual office using the movement path data.

In some aspects, performing the update on the movement means from the first space to the second space inside the virtual office may include performing any one of generation, removal, and position change on a movement portal from the first space to the second space.

In some aspects, acquiring the movement path data in the virtual office may include acquiring movement path data of an outsider in the virtual office. In some aspects, performing any one of generation, removal, and position change on the movement portal from the first space to the second space may comprise determining whether to generate a movement portal from the first space to the second space by using the movement path data of an outsider. In some aspects, the movement portal is available only to an avatar of an outsider or an avatar of an employee accompanying the outsider.

In some aspects, performing the update on the layout of the virtual office may include redisposing at least one of the first space or the second space such that a distance between the first space and the second space inside the virtual office is adjusted using the movement path data.

In some aspects, performing the update on the layout of the virtual office may include adjusting graphic properties of a movement passage to widen the movement passage from the first space to the second space inside the virtual office by using the movement path data.

According to still another embodiment of the present disclosure, a computer-implemented method for managing space of a physical office and a virtual office comprises acquiring physical office resource utilization data, determining whether the physical office is congested by analyzing the physical office resource utilization data, and if it is determined that the physical office is congested as a result of the determination, performing a process to promote use of the virtual office.

In some aspects, the process to promote use of the virtual office may include transmitting a physical office congestion situation indication and a virtual office usage guide to an employee terminal device during a reservation process for a physical office resource.

In some aspects, the process to promote use of the virtual office may include determining whether to approve a reservation by reflecting performance of the virtual office during a reservation process for a physical office resource.

In some aspects, the process to promote use of the virtual office may include transmitting a physical office congestion situation indication and a virtual office usage guide to a terminal device of a target employee who occupies or has reserved a physical office resource that can be migrated to the virtual office, among employees selected by using virtual office use history and occupancy of the physical office resource.

In some aspects, the process to promote use of the virtual office may include transmitting a physical office congestion situation and a virtual office usage guide to a terminal device of a target employee for whom productivity of a virtual office resource corresponding to a currently occupied physical office resource is evaluated to be higher than productivity of a physical office resource currently occupied or being requested for reservation, among the target employees.

In some aspects, the physical office resource that can be migrated to the virtual office may be a conference room, and the productivity may be evaluated based on at least one of occupation time, communication traffic generated during occupation, quality of a product generated during occupation, or reservation time extension history of the conference room.

In some aspects, the process to promote use of the virtual office may include performing an update to extend a first resource of the virtual office corresponding to a first resource of the physical office determined to be congested.

### BRIEF DESCRIPTION OF THE DRAWINGS

The above and other aspects and features of the present disclosure may become more apparent from the following detailed description in conjunction with the accompanying drawings, in which:

FIG. 1 is a configuration diagram of a work portal management system, according to an embodiment of the present disclosure;

FIGS. 2 to 4 are diagrams for explaining functional elements that may be serviced in the work portal management system described with reference to FIG. 1, according to embodiments of the present disclosure;

FIG. 5 is a diagram for explaining in detail an operation of the work portal management system described with reference to FIG. 1, according to an embodiment of the present disclosure;

FIG. 6 is a block diagram of an office space management apparatus, according to an embodiment of the present disclosure;

FIG. 7 is a flowchart of an office space management method, according to an embodiment of the present disclosure;

FIGS. 8 and 9A-D are diagrams of example physical office layouts that may be generated in the method described with reference to FIG. 7, according to embodiments of the present disclosure;

FIG. 10 is a flowchart of an office space management method that may be performed in addition to the method described with reference to FIG. 7, according to some embodiments of the present disclosure;

FIG. 11 is a flowchart of an office space management method, according to another embodiment of the present disclosure;

FIGS. 12 and 13A-C are diagrams of example virtual office layouts that may be generated in the method described with reference to FIG. 11;

FIGS. 14 and 15 are flowcharts of office space management methods that may be performed in addition to the method described with reference to FIG. 11, according to embodiments of the present disclosure;

FIGS. 16 to 17 are flowcharts of office space management methods, according to still other embodiments of the present disclosure; and

FIG. 18 is a hardware configuration diagram of the office space management apparatus described with reference to FIG. 6, according to an embodiment of the present disclosure.

### DETAILED DESCRIPTION

Hereinafter, embodiments of the present disclosure are described with reference to the accompanying drawings. Advantages and features of the present disclosure and methods of accomplishing the same may be understood more readily by reference to the following detailed description of the embodiments and the accompanying drawings. The present disclosure may, however, be embodied in many different forms and should not be construed as being limited to the embodiments set forth herein.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof is omitted.

Unless otherwise defined, all terms used in the present specification (including technical and scientific terms) may be used in a sense that can be commonly understood by those having ordinary skill in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component. When a component, device, module, unit, element, or the like of the present disclosure is described as having a purpose or performing an operation, function, or the like, the component, device, or element should be considered herein as being “configured to” meet that purpose or to perform that operation or function.

Hereinafter, embodiments of the present disclosure are described with reference to the accompanying drawings.

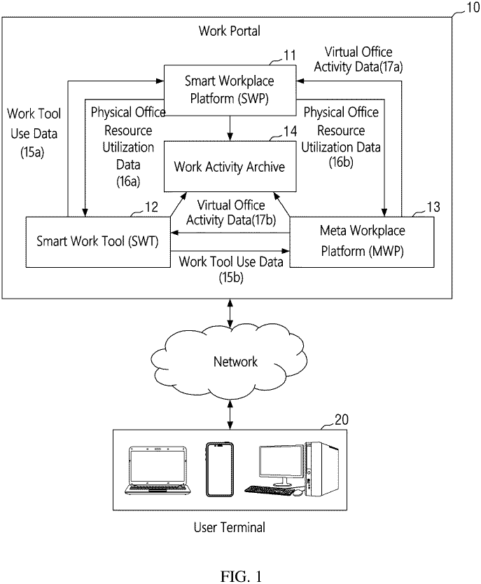

First, a work portal management system according to one embodiment of the present disclosure is described with reference to FIG. 1. The work portal management system according to the present embodiment may include one or more server apparatuses (not illustrated) servicing a work portal 10. Screen rendering data generated by the one or more server apparatuses servicing the work portal 10 may be transmitted to a user terminal 20 over a network, and the user terminal 20 may render the screen rendering data to display a screen related to the work portal.

The work portal 10 may be a service that provides various functions for employees to perform their work in an integrated manner. As illustrated in FIG. 1, the work portal 10 may service a smart workplace platform (SWP) 11, a smart work tool (SWT) 12, and a meta workplace platform (MWP) 13.

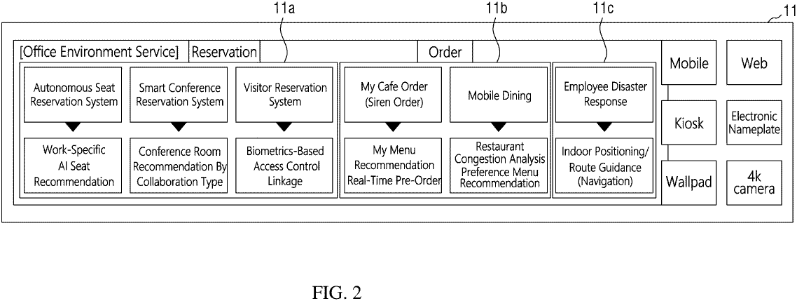

Hereinafter, the smart workplace platform 11, according to an embodiment, is described with reference to FIG. 2.

The smart workplace platform 11 provides services for the work and overall life of the employees in a physical office. The smart workplace platform 11 may operate by transmitting and receiving data to and from various apparatuses installed in physical offices. The various apparatuses installed in physical offices may include IoT sensors that collect worker work patterns and environmental data. The IoT sensors may include, but are not limited to, CCTVs, temperature sensors, humidity sensors, air quality sensors, sound sensors, vibration sensors, and illumination sensors. The various apparatuses installed in physical offices may, additionally or alternatively, include access control solutions based on face recognition and card recognition, electronic nameplates that reserve and display the reservations and use of seats and conference rooms, restaurant and cafe POSs, position recognition and occupancy detection sensors and solutions, wired and wireless networks, electronic boards and video conferencing solutions, detection solutions for disasters and emergencies such as fire and earthquakes, service robots and control solutions, parking control and payment and electric vehicle charging solutions, power control solutions, lighting control solutions, air conditioning control solutions, elevator control solutions, and energy control and building integrated management solutions.

In order to provide integrated services in the physical office, the smart workplace platform 11 may collect data from various apparatuses and solutions in low levels, and may control or service each apparatus or solution by linking some or all functions.

In some embodiments, as illustrated in FIG. 2, the smart workplace platform 11 may provide a reservation service 11a for various resources of a physical office for the convenience of the employees. For example, the smart workplace platform 11 may provide an autonomous seat reservation service including an AI-based seat recommendation function, a conference room reservation service including an AI-based conference room recommendation function, and a visitor reservation service linked with an access control solution. The smart workplace platform 11 may also provide an ordering service 11b linked with a point of service (POS) apparatus of an in-house restaurant or an in-house cafe.

In some embodiments, the smart workplace platform 11 may provide a disaster response service 11c that serves as an interface for guiding the evacuation routes of the employees in the event of a disaster or conducting disaster response training.

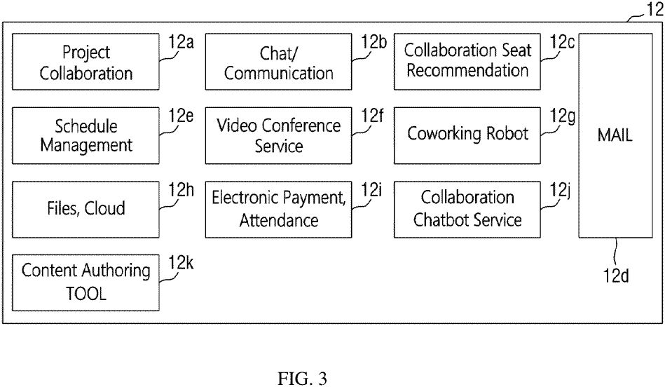

Hereinafter, the smart work tool 12, according to an embodiment, is described with reference to FIG. 3. The smart work tool 12 may include various software tools used in the process of performing work or in the process of inputting the result after performing the work. For example, as illustrated in FIG. 3, the smart work tool 12 may include a project collaboration tool 12a, a chat and communication tool 12b, a collaboration seat recommendation tool 12c, a schedule management tool 12e, a video conference tool 12f, a co-working robot tool 12 g such as robotics process automation (RPA), a cloud storage service 12h, an electronic payment and attendance management service 12i, a chatbot service 12j, and a content authoring tool 12k for various types of contents such as documents, spreadsheets, or presentation data.

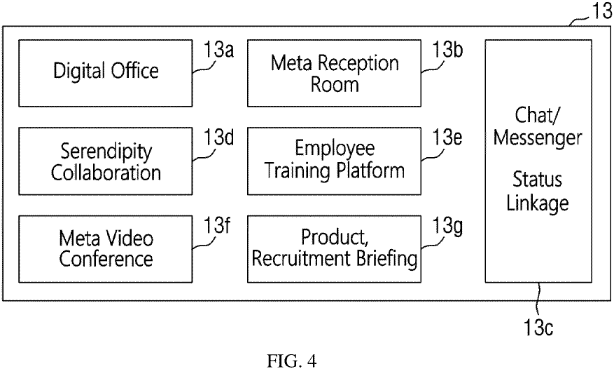

Hereinafter, the meta workplace platform 13, according to an embodiment, is described with reference to FIG. 4.

The meta workplace platform 13 may be a platform servicing a virtual office. For example, the meta workplace platform 13 may be a system that provides a virtual office and work environment to the employees through a metaverse solution and provides new convenience services through linkage with a physical office environment and work system.

The meta workplace platform 13 may be implemented using a plurality of functional elements. These functional elements may include i) a digital office element 13a that disposes buildings, furniture, nature, landscape elements, and the like in a virtual office space in a form similar to the physical office space, ii) metahuman elements, such as the actual employees logging into the system, chatbots, and NPCs, that are active in the meta workplace and communicate with each other, iii) an interface element that links data on overall virtual office environment activities and data of the physical office environment and various work tools, iv) service elements that provide services such as metahuman activity support and entry and leave input in digital offices, voice recognition-based data search, video conferencing, conference room reservation and move, schedule reservation and confirmation, mail and message confirmation and creation, document co-creation, large-scale events, non-face-to-face training and interviews, and v) a system server element for installation and operation of platform SW, OS, security SW, and the like.

The meta workplace platform 13 may also provide a meta reception room 13b. The meta reception room 13b may be a virtual space that, in preparation for a digital office that only the employees may access, may be accessed by outsiders as well.

The meta workplace platform 13 may also provide an open space 13d that facilitates serendipity collaboration may also be provided. This open space may not be accessible to outsiders, but may be a virtual space accessible to all employees.

The meta workplace platform 13 may also allow activities typically performed offline, such as an employee training platform 13e, meta video conference 13f, and product or recruitment briefing 13 g, to be performed in a virtual space built on a virtual office.

In some embodiments, the state information of metahumans that are active in the virtual office space may be linked with information that may be acquired from the smart work tool 12 such as a messenger, and the meta workplace platform 13 may further include such a state information linkage module 13c.

In the work portal 10, the smart workplace platform 11, the smart work tool 12, and the meta workplace platform 13 may transmit and receive data to and from each other, and thus may expand or enhance the service of the work portal 10.

The smart work tool 12 may provide work tool use data 15a to the smart workplace platform 11. The smart workplace platform 11 may identify the type of work tool currently being used by the employees and the current work progress status of the employees based on the work tool use data 15a. In an embodiment, the smart workplace platform 11 may provide a reservation-related suggestion function according to the situation of the employees. For example, the smart workplace platform 11 may suggest ordering iced coffee to the employees who continuously create documents for an hour or more using a document creation tool.

The smart work tool 12 may also provide work tool use data 15b to the meta workplace platform 13. The meta workplace platform 13 may identify the type of work tool currently being used by the employees and the current work progress status of the employees based on the work tool use data 15b. In an embodiment, the meta workplace platform 13 may display the status information of the employees’ avatars that are active in the virtual office. For example, the smart workplace platform 11 may automatically change the appearance of the avatar of an employee to a form indicating Do Not Disturb such that an employee who continuously creates a document for more than an hour using a document creation tool may concentrate on the work.

The smart workplace platform 11 may provide physical office resource utilization data 16a to the smart work tool 12. The smart work tool 12 may identify information about conference rooms reserved by employees, and output conference room reservation alarms through messengers, schedulers, and the like. In some embodiments, the smart work tool 12 may also identify the position of autonomous seats reserved by employees, and identify the environment of the autonomous seat position. In an embodiment, when the identified environment is an environment with a lot of noise and a lot of movement, a UI theme of the smart work tool 12 is automatically set as static as possible, so that care may be given to the employees not to be stressed by the environment.

The smart workplace platform 11 may also provide physical office resource utilization data 16b to the meta workplace platform 13. When the virtual office is implemented identically to the physical office as much as possible for the implementation of the digital twin, the meta workplace platform 13 may express the behavior of employees in the physical world on the virtual office in the same manner by using the physical office resource utilization data 16b.

For example, the meta workplace platform 13 may identify information about a conference room reserved by an employee and automatically move the position of the avatar of the employee to the reserved conference room at the conference start time. As another example, the meta workplace platform 13 may use the physical office resource utilization data 16b to identify information on autonomous seats reserved by employees, and may also identify information on whether the employees are seated in the corresponding seats. Accordingly, an act of an employee reserving an autonomous seat at a specific position and sitting in the seat may be expressed identically in real time in the virtual office. Thus, although they are not together in the physical office, the current situation of the colleagues may be visually recognized. In this way, limitations in terms of the situational awareness of telecommuting as compared to commuting to work may be at least partially overcome.

The meta workplace platform 13 may provide virtual office activity data 17a to the smart workplace platform 11. The smart workplace platform 11 may identify what activities employees are performing in the virtual office based on the virtual office activity data 17a, and may display recommendations for resource reservation in the physical office. For example, while an employee A and an employee B who met by chance in a public hall for serendipity collaboration in a virtual office actively communicate, when the employee A requests a reservation for a conference room that may be used immediately, the employee B may automatically be recommended as a conference participant. In other words, the virtual office activity data 16a may be information that supports the migration of metahuman activities from the virtual conference room to the physical office.

The smart workplace platform 11 may identify what kind of communication the employees are having in the virtual office based on the virtual office activity data 17a, and may also display recommendations for ordering food or beverages in a physical office or making a reservation. For example, in the process of an employee C making a reservation for an employee restaurant after recently discussing in a virtual office that the employee C and an employee D should have a meal together, the smart workplace platform 11 may suggest to add the employee D to the reservation list.

The smart workplace platform 11 may identify what activities the employees perform in the virtual office based on the virtual office activity data 17a, and may also automatically adjust the environment of the physical office. For example, when an employee E has frequent communications and meetings in the virtual office, the smart workplace platform 11 may automatically control the cooling of the surrounding environment of the employee E.

The meta workplace platform 13 may also provide virtual office activity data 17b to the smart work tool 12. The smart work tool 12 may relay an employee’s activity in the virtual office to the work tool by using the virtual office activity data 17b. For example, the contents of conversation between the employee E and an employee F in the virtual office may be mutually transmitted and received through e-mail. The smart work tool 12 may use the virtual office activity data 17b to identify details of the activities of employees in the virtual office, automatically input information corresponding to the details into the work tool, and thus provide support such that the activities of the employees in the virtual office are automatically recorded as work outcomes.

Data generated by the smart workplace platform 11, the smart work tool 12, and the meta workplace platform 13, including the above-described physical office resource utilization data, virtual office activity data, and work tool use data, may be recorded in a work activity archive 14.

As used herein, work activity data may be understood as an expression referring to data recorded in the work activity archive 14. Accordingly, the work activity data may include at least some of the physical office resource utilization data, the virtual office activity data, and the work tool use data.

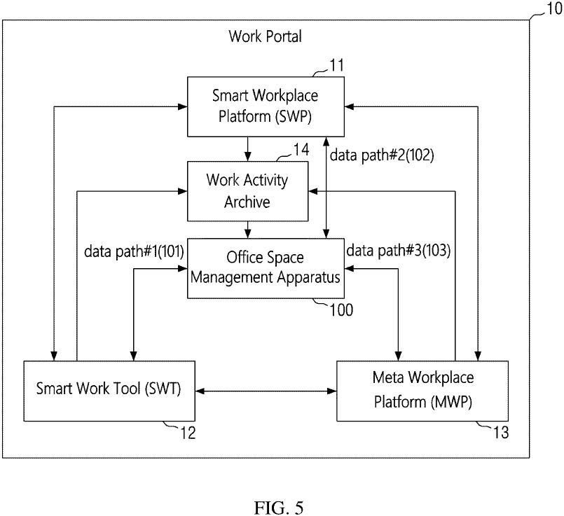

Hereinafter, the operation of the work portal management system, according to an embodiment, is described in more detail with reference to FIG. 5. The work portal management system according to an embodiment may include an office space management apparatus 100 configured to provide a function of managing office space. The office space management apparatus 100 may initially generate or optimize the layout of a physical office or virtual office, generate a reorganization suggestion by using the optimization result, update the layout of the virtual office, and automatically perform a process to promote the use of the virtual office in a physical office congestion situation.

The office space management apparatus 100 according to an embodiment of the present disclosure may perform the above-described function using data provided from the work activity data archive 14. However, because the data stored in the work activity data archive 14 may be data that is obtained by processing data collected from the smart workplace platform 11, the smart work tool 12, or the meta workplace platform 13 in a standard format, the data may not accurately reflect the real time situation.

Accordingly, in some embodiments, the office space management apparatus 100 may directly transmit and receive data to and from the smart workplace platform 11, the smart work tool 12, and/or the meta workplace platform 13 through, respectively, a first data path 101, a second data path 102, and a third data path 103. In an embodiment, the office space management apparatus 100 may initially generate or optimize the layout of a physical office or virtual office, generate a reorganization suggestion using the optimization result, update the layout of the virtual office, and perform a process to promote the use of the virtual office in the physical office congestion situation by using at least some of the work tool use data provided in real time from the smart work tool 12, the physical office resource utilization data provided in real time from the smart workplace platform 11, and the virtual office activity data provided in real time from the meta workplace platform 13.

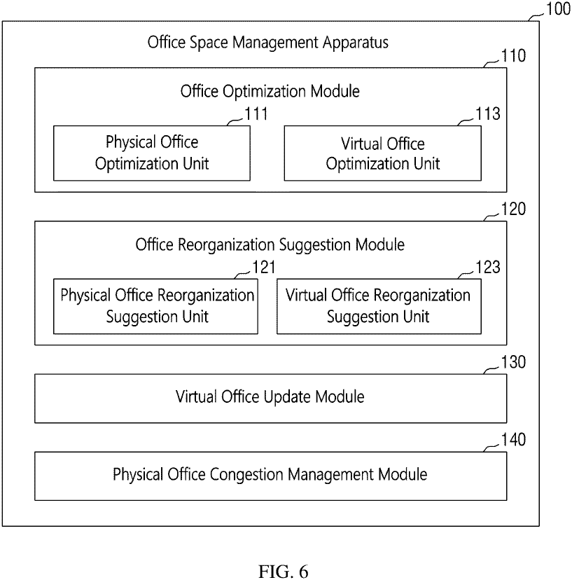

The office space management apparatus 100 according to an embodiment may include an office optimization module 110, an office reorganization suggestion module 120, a virtual office update module 130, and a physical office congestion management module 140 as illustrated in FIG. 6. The office space management apparatus 100 may operate with only some of the modules 110, 120, 130, 140 illustrated in FIG. 6 activated, and the activated modules may be designated by environment settings.

In an embodiment, the office space management apparatus 100 may automatically determine modules to be activated by using the work tool use data provided in real time from the smart work tool 12, the physical office resource utilization data provided in real time from the smart workplace platform 11, and the virtual office activity data provided in real time from the meta workplace platform 13. Accordingly, the office space management apparatus 100 may save computing resource use by activating only the module corresponding to the real-time situation. The operation of the office optimization module 110, according to an embodiment, is now described.

The office optimization module 110 acquires the work activity data of one or more employees and determines an optimal office layout by using the work activity data. The office optimization module 110 includes a physical office optimization unit 111 that determines the layout of the physical office by using the work activity data and a virtual office optimization unit 113 that determines the layout of the virtual office by using the work activity data.

In the present disclosure, the “layout” of an office is not limited to the floor plan configuration of a specific space of the office, but may be understood as a concept defining the space constituting the office, such as a space ratio for each type of the entire office and the floor plan configuration of a specific space. In addition, in the present disclosure, the layout of an office may refer to a physical office as well as a virtual office. The layout of the virtual office may be understood as a concept defining the space constituting the virtual office, such as a space ratio for each type of the entire virtual space constituting the virtual office and the floor plan configuration of a specific virtual space.

In some embodiments, the physical office optimization unit 111 may use first type of work activity data to determine the layout, and the virtual office optimization unit 113 may use second type of work activity data to determine the layout.

The first type of work activity data may include all of the work tool use data, the physical office resource utilization data, and the virtual office activity data. The physical office optimization unit 111 may identify the work type of each employee by considering how employees utilize physical office resources, how employees use work tools, and what activities employees show in the virtual office, and may automatically generate the optimal layout of the physical office by reflecting the identified work type.

The second type of work activity data may include only the work tool use data and the virtual office activity data. The virtual office optimization unit 113 may predict the activity of each employee in the virtual office by considering how the work tool is used and what activities are shown in the virtual office, estimate the amount of activities in the entire virtual office according to the expected activity of each employee, and automatically generate the optimal layout of the virtual office by reflecting the estimated amount of activities.

The second type of work activity data may also be constituted with only the work tool use data and the physical office resource utilization data. The virtual office optimization unit 113 may determine the quantity of each resource disposed in the virtual office by using the physical office resource utilization data, and may determine the properties of each resource disposed in the virtual office by using the work tool use data.

In an example embodiment in which the virtual office optimization unit 113 optimally disposes conference rooms in a virtual office, the number of reservations for the physical office conference rooms of all employees may be identified from the physical office resource utilization data. The total number of conference room reservations identified in this way may generally be regarded as indicating the demand for the conference room. Accordingly, the virtual office optimization unit 113 may determine the number of conference rooms disposed in the virtual office by using the total number of conference room reservations.

In some embodiments, the average value of the number of concurrent communication partners of each employee may be identified from the work tool use data. The number of concurrent communication partners may be calculated using, for example, the average number of members of a group chat room or the average number of mail recipients and references. It may be seen that the higher the average value of the number of concurrent communication partners of all employees, the more employees will need a conference room capable of accommodating several people. Accordingly, the virtual office optimization unit 113 may determine the size distribution of conference rooms disposed in the virtual office by using the average value of the number of concurrent communication partners of employees.

In some embodiments, the virtual office optimization unit 113 may determine the work type for each employee by using the work tool use data of each employee, aggregate the number of employees for each work type, and determine the properties of each resource by using the result of the aggregation.

In an example embodiment in which conference room disposition is performed, the virtual office optimization unit 113 may increase the ratio of the blocking type conference room as the employee ratio of the intensive work type increases. This is because employees of the intensive work type prefer a conference environment that is cut off from the surroundings although a conference is conducted.

In some embodiments, the virtual office optimization unit 113 may add-on a specific object to a resource in order to satisfy the properties of each resource in the virtual office that matches the work type ratio of the employee.

The object may be understood as a kind of item that may be added-on to a space of a virtual office or a specific resource. For example, the virtual office optimization unit 113 may generate the optimal virtual office layout by default-disposing blocking objects, which may be added-on to conference rooms, in some conference rooms as the employee ratio of the intensive work type increases. In this way, the object brings about an effect of changing the properties of resources in a simple way (e.g., conference rooms, work seats, and resting spaces). Accordingly, by utilizing the object, it is possible to obtain a cost effect of not having to design or develop all resources of various properties.

The physical office optimization unit 111 and the virtual office optimization unit 113 may determine the layout by using the same work activity data. That is, the layout of the physical office and the layout of the virtual office may be optimized to reflect the same information. For example, when the virtual office is operated as a digital twin of the physical office, the physical office optimization unit 111 and the virtual office optimization unit 113 may determine the layout by using the same work activity data.

The physical office optimization unit 111 and the virtual office optimization unit 113 may determine the work type of each employee by using the work activity data, and determine the optimal ratio for each property of office resources by using the number of employees for each work type.

For example, collaborative work type scores may be computed based on the data such as the frequency of conversations in the virtual office of a specific employee, the volume of message chatting, the response speed in chatting and virtual offices, the number of project members, the number of projects, conference progress time, the number of conferences, members in conference progress, conference schedule data, and the number of conference calls.

The concentration type score may be computed based on data such as the meeting schedule of a specific employee, seating holding time of individual seats, individual work progress time, the status update time and object use time related to personal intensity in the virtual office, and level of activation of input apparatuses.

Optimal ratios of seat resources, conference room resources, and resting space resources may be determined using the number of employees for each work type.

For example, in order to optimize the physical office layout of the office space on the tenth floor, the physical office optimization unit 111 may calculate the ratios of, with respect to employees working on the tenth floor, employees of the intensive work type, employees of the same floor collaboration type, employees of the external floor collaboration type, and employees of the outsider collaboration type, and may automatically calculate a space ratio for each type of tenth floor by using the calculated ratios.

In an embodiment, the layout of the office space on the tenth floor may be automatically generated to include intensive work seats with the number of seats corresponding to the employee ratio of the intensive work type, open type work seats with the number of seats corresponding to the employee ratio of the same floor collaboration type, open type work seats corresponding to the employee ratio of the external floor collaboration type, and open type work seats corresponding to the employee ratio of the outsider collaboration type.

In an embodiment, it may be desirable to maintain the one-to-one ratio between the number of employees of the intensive work type and the number of intensive work seats, and it may also be desirable to maintain the one-to-one ratio between the number of employees of the same floor collaboration type and the number of open type work seats. However, since the employees of the external floor collaboration type may have work spaces also on the external floor, the ratio between the number of employees of the external floor collaboration type and the number of open type work seats may be 1:N (N is a real number less than 1). Further, since the employees of the outsider collaboration type frequently work out of the office, the ratio between the number of employees of the outsider collaboration type and the number of open type work seats may also be 1:M (M is a real number less than 1, M <N). The values of M and N may be dynamically determined according to the external floor collaboration demand and the out-of-office demand analyzed through the work activity data.

In some embodiments, the layout of the office space on the tenth floor may include a conference room area at a ratio determined based on conference demand calculated using the number of employees for each work type. The conference room area may be divided into a plurality of conference room spaces based on an analysis result of the distribution of meeting personnel. For example, when the number of meeting personnel is generally small, e.g., 4 or less, the conference room area may be divided to include as many conference rooms as possible for 4 people.

When the serviced virtual office is a digital twin concept virtual office, the virtual office optimization unit 113 may automatically determine the virtual office layout in the same way as the physical office optimization unit 111. On the other hand, when the virtual office implements the virtual space different from the physical office, the virtual office optimization unit 113 may use the number of employees for each work type to automatically determine the virtual office layout in a way that determines the optimal ratio for each property of office resources disposed in the virtual space of the entire virtual office.

For example, while a physical office is a ten-story building, a virtual office may be implemented as a single-story virtual space, and office resources of each property may be disposed in the single-story virtual space. In an embodiment, the virtual office optimization unit 113 may determine area ratios of a work seat, a conference room, a resting space, a serendipity collaboration hall, and a reception hall for outsiders based on the ratio of employees for each work type.

The operation of the office reorganization suggestion module 120, according to an embodiment, is now described.

The office reorganization suggestion module 120 evaluates a difference between the layout automatically generated by the office optimization module 110 and the current layout, and automatically generates an office reorganization suggestion based on the evaluated difference.

The office reorganization suggestion module 120 includes a physical office reorganization suggestion unit 121 and a virtual office reorganization suggestion unit 123. In an embodiment, the physical office reorganization suggestion unit 121 computes a higher need score for the office reorganization suggestion as the difference between i) the ratio of the intensive work seat to the open type work seat according to the automatically generated tenth floor layout and ii) the ratio of the intensive work seat to the open type work seat according to the current tenth floor layout increases. In addition, the physical office reorganization suggestion unit 121 computes a higher need score for the office reorganization suggestion as the difference between i) the ratio of the work seat area to the conference room area according to the automatically generated tenth floor layout and ii) the ratio of the work seat to the conference room according to the current tenth floor layout increases.

In an embodiment, the virtual office reorganization suggestion unit 123 also computes a higher need score for the office reorganization suggestion as the difference between i) the area ratio of work seats, conference rooms, resting spaces, serendipity collaboration halls, and reception hall for outsiders of the automatically generated virtual office and ii) the area ratio of work seats, conference rooms, resting spaces, serendipity collaboration halls, and reception hall for outsiders of the virtual office being operated increases.

The physical office reorganization suggestion unit 121 and the virtual office reorganization suggestion unit 123 may automatically generate an office reorganization suggestion when the difference between the automatically generated optimal office layout and the current office layout exceeds a reference value, and may transmit the office reorganization suggestion to the administrator’s terminal device.

The office reorganization suggestion may include information on the optimal office layout and may include information on the difference. The office reorganization suggestion may be, for example, an automatically created e-mail. In addition, the virtual office reorganization suggestion unit 123 may transmit a button enabling performance of a virtual office update with an optimal virtual office layout together with the office reorganization suggestion.

The operation of the virtual office update module 130, according to an embodiment, is now described.

The virtual office update module 130 may use the virtual office layout generated by the virtual office optimization unit 113 to update the virtual office currently being serviced. Unlike physical offices, which require construction to change the office layout, virtual offices only require software updates.

The virtual office update module 130 may evaluate an avatar density and update the virtual office layout such that the avatar density is positioned within a normal range. For example, when the density of avatars falls short of the normal range, the virtual office update module 130 may perform an update in which the space area of the virtual office is reduced. Conversely, when the avatar density exceeds the normal range, the virtual office update module 130 may perform an update in which the space area of the virtual office is increased. Thus, the virtual office update module 130 may dynamically adjust the space size of the virtual office such that employees may feel an appropriate population density within the virtual office.

The virtual office update module 130 may also perform an update in terms of route optimization. Unlike video conferencing solutions, the virtual office may place importance on the user experience of colleagues gathering during work hours, has serendipity collaboration, which enables employees to receive work help and solve problems by chance encounters and conversations, as one of its main purposes, and thus the virtual office may provide a user experience in which the avatars of the employees move inside the virtual office.

However, when the movement path is not optimized, the employees may regard the process of moving as a waste of time, which may have an adverse effect on participation in the virtual office. Accordingly, in order to prevent this, the virtual office update module 130 may perform an update in terms of path optimization separately from an update for reflection of an optimal layout.

The virtual office update module 130 may analyze the virtual office movement path data of each employee and the virtual office movement path data of an outsider. The analysis may include operations on several metrics.

The metrics may include the number of avatars encountered from movement start to movement completion, and a movement distance from movement start to movement completion. When the number of avatars and the movement distance deviate from the normal numerical range, the virtual office update module 130 may perform an automatic update of the virtual office layout.

For example, in a situation where the movement from a first space to a second space inside the virtual office is frequent and the value of the metric deviates from the normal numerical range, the virtual office update module 130 may redispose at least one of the first space or the second space such that the distance between the first space and the second space is adjusted. As another example, when too many avatars are encountered on average in the process of moving from the first space to the second space, it may be determined that the space of the movement path is too narrow, and thus the virtual office update module 130 may adjust graphic properties of a movement passage such that the movement passage from the first space to the second space is widened.

In a situation where the movement from the first space to the second space inside the virtual office is frequent and the value of the metric deviates from the normal numerical range, the virtual office update module 130 may perform an automatic update on a movement means from the first space to the second space.

For example, the virtual office update module 130 may perform any one of generation, removal, and position change on a movement portal from the first space to the second space. When the avatar enters the movement portal, the avatar may move directly to the opposite movement portal, so that the time required to move may be greatly saved.

However, when the movement portal is overused, there is a problem that serendipity collaboration becomes difficult, and thus the movement portal should be generated in a limited manner, such as the movement path when accompanying an outsider. In this regard, in some embodiments, the virtual office update module 130 may determine whether to generate a movement portal from the first space to the second space by using movement history data of an outsider. In addition, the movement portal may be implemented such that the movement portal is available only to an avatar of an outsider or an avatar of an employee accompanying the outsider.

The operation of the physical office congestion management module 140, according to an embodiment, is now described.

The physical office congestion management module 140 may determine whether the physical office is congested by analyzing the physical office resource utilization data. The physical office congestion management module 140 may determine whether the physical office is congested by analyzing a reservation system PV (Page View), the number of reservation attempts in the reservation system, and the like.

In some embodiments, the physical office congestion management module 140 may evaluate the relative congestion rate of a physical office relative to a virtual office. For example, the physical office congestion management module 140 may determine that the physical office congestion situation is present when the congestion rate of the physical office scored in a predetermined method is higher than the congestion rate of the virtual office also scored in a predetermined method by a reference value or more. In at least some embodiments, the reason for evaluating the relative congestion rate is that it is meaningful to promote the use of the virtual office only when the physical office is congested while the virtual office is not congested.

The congestion rate of the physical office may be computed using at least some of a number of entered people, a number of people sitting on work seats, a number of people who have reservations for work seats, and a ratio of occupied conference rooms. The congestion rate of the virtual office may be computed using at least some of a number of connected people, a number of people sitting in work seats, an average density of moving avatars, and a ratio of occupied conference rooms.

The physical office congestion management module 140 may automatically perform a process to promote the use of the virtual office when it is determined that the physical office congestion situation is present.

The process may include transmitting a physical office congestion situation indication and a virtual office usage guide to an employee terminal device during a reservation process for a physical office resource. Further, the process may include determining whether to approve the reservation by reflecting the performance of the virtual office during the reservation process for the physical office resource. Accordingly, some of the physical office resource reservations may be converted to virtual office access.

The above process may include a process of transmitting the physical office congestion situation indication and a virtual office usage guide to the terminal device of the target employee who occupies or has reserved a physical office resource that may be migrated to a virtual office, among the employees selected by using the virtual office use history and the occupancy of the physical office resource. Accordingly, the process may be performed by targeting employees with a high probability of migration to the virtual office, so that the success rate of migration to the virtual office may be increased.

An example physical office resource that may be migrated to the virtual office is a conference room or a work seat. In an embodiment, since the work seat is a minimum basic resource for an employee to settle in the physical office, the process to promote the use of work seats in the virtual office may be automatically performed only when the terminal of the employee is at least a predetermined distance away from the physical office. For example, when employees want to make reservations for autonomous seats in the physical office before going to work offline from home, a process to promote the use of work seats in the virtual office may be performed.

The above process may include a process of transmitting the physical office congestion situation indication and the virtual office usage guide to the terminal device of the target employee for whom the productivity of the virtual office resource corresponding to the currently occupied physical office resource is evaluated to be higher than the productivity of the physical office resource currently occupied or being requested for reservation, among the target employees. When the physical office resource currently being requested for reservation is a conference room, the productivity may be evaluated based on the reservation time extension history of the conference room. As a result, it is possible to target an employee exhibiting higher productivity in the virtual office and migrate the work space of the employee to the virtual office, rather than simply leading the employee from the physical office to the virtual office.

The process may include automatically performing an update to extend a first resource of the virtual office corresponding to a first resource of the physical office determined to be congested. In an embodiment, there is a high possibility that the first resource of the virtual office is selected as an alternative due to the congestion situation of the first resource, and thus by securing a sufficient supply of the first resource of the virtual office in advance, the migration from the physical office to the virtual office may be facilitated.

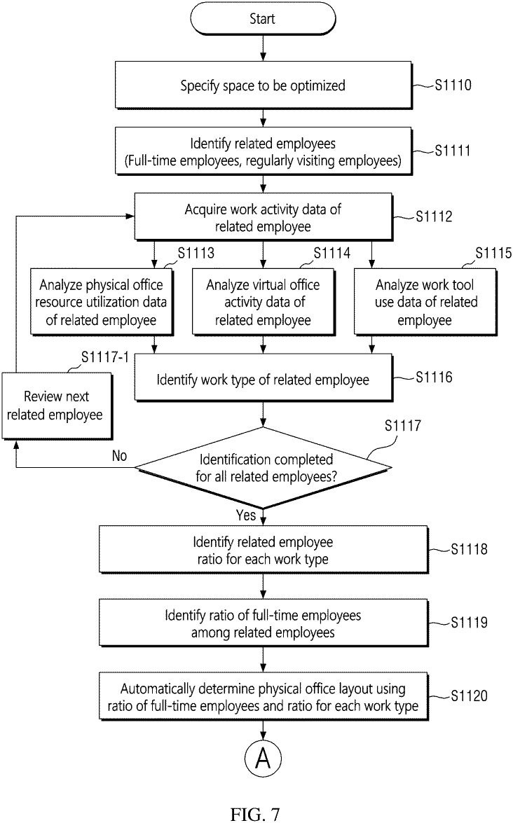

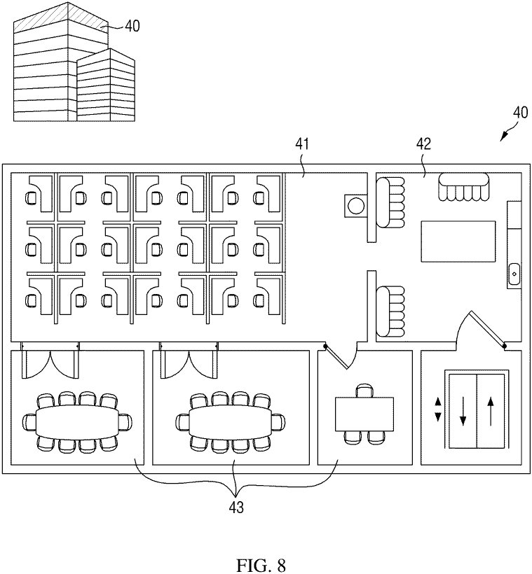

Hereinafter, an office space management method according to an embodiment of the present disclosure is described with reference to FIGS. 7 to 17. The office space management method according to an embodiment may be performed by one or more computing apparatuses. In other words, in the office space management method according to an embodiment, all operations may be performed by one computing apparatus, or some operations may be performed by another computing apparatus. For example, some operations may be performed by a terminal device and other operations may be performed by a server apparatus. In some embodiments, the server apparatus may be implemented on a cloud computing node, and operations performed by the server apparatus may be divided and performed on a plurality of cloud computing nodes. Hereinafter, in describing the method according to the present embodiment, description of a performer of some operations may be omitted. It should be understood that, in various embodiments, the subject performing the corresponding operation is the computing apparatus. Hereinafter, the computing apparatus is sometimes referred to as an “office space management apparatus.”

The office space management method according to an embodiment may include operations reflecting the technical spirit of some embodiments described with reference to FIGS. 1 to 6. For convenience of understanding, operations according to some embodiments described with reference to FIGS. 1 to 6 are not described redundantly or are described briefly.

First, a method for determining a physical office layout is described with reference to FIG. 7.

In a step S1110, a space to be optimized is specified from among a plurality of spaces included in a physical office. The space to be optimized may be designated by user input or may be automatically selected based on a specific metric such as a conference room reservation rate.

In a step S1111, employees related to the space to be optimized are identified. For example, when the space to be optimized is an office space on the fifth floor, employees who work full-time on the fifth floor and employees who regularly visit the fifth floor may be identified as related employees.

Although FIG. 7 illustrates that after the space to be optimized is specified, employees related to the specified space are identified, in another embodiment, after employees who are the target of the physical office layout are first designated, a specific space in the physical office related to the designated employees may be selected.

Next, operations are performed to identify the work type of each related employee. These operations may include acquiring work activity data of a related employee in a step S1112, analyzing physical office resource utilization data as the work activity data in a step S1113, analyzing virtual office activity data in a step S1114, and analyzing work tool use data in a step S1115. In a step S1116, based on the above analysis, the work type of the related employee may be identified.

In steps S1117 and S1117-1, operations for identifying the work type of the related employee are repeated until the identification of the work type is completed for all related employees.

When the work type identification of each related employee is completed in the step S1117, the related employee ratio for each work type may be identified in a step S1118. For example, the ratio of (intensive work type: collaboration type) may be identified.

An optimal ratio for each property of office resources may be determined using the related employee ratio for each work type. Accordingly, in a step S1120, the physical office layout may be automatically determined.

In some embodiments, in a step S1119, the stability of the layout may be supplemented by automatically determining the physical office layout by further using a ratio of full-time employees having a relatively low possibility of situation changes among the related employees. For example, when the ratio of full-time employees is lower than a reference value, the ratio of open type seats included in the layout is adjusted to increase, so that a layout capable of flexibly coping with situational changes may be generated.

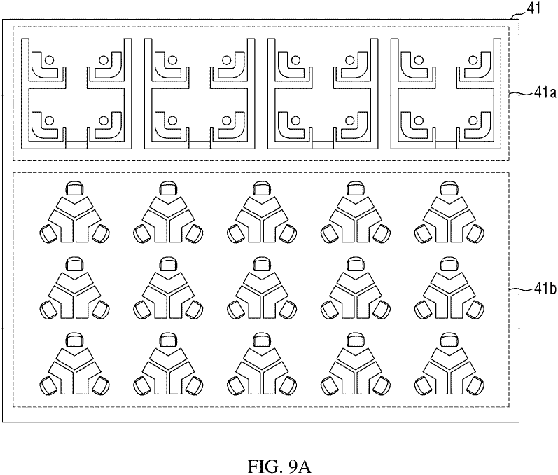

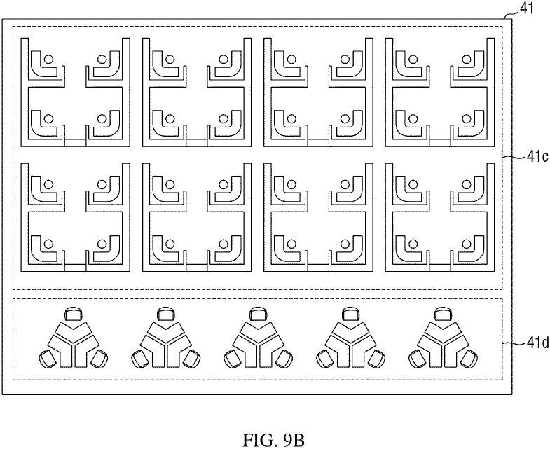

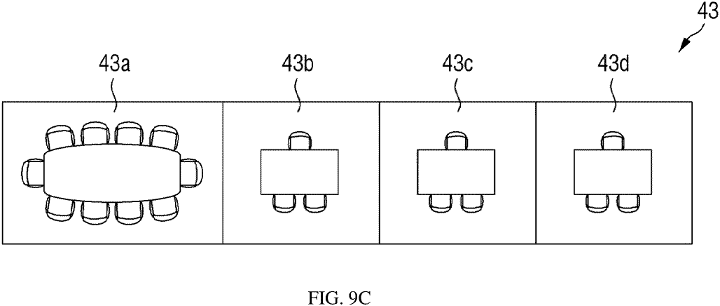

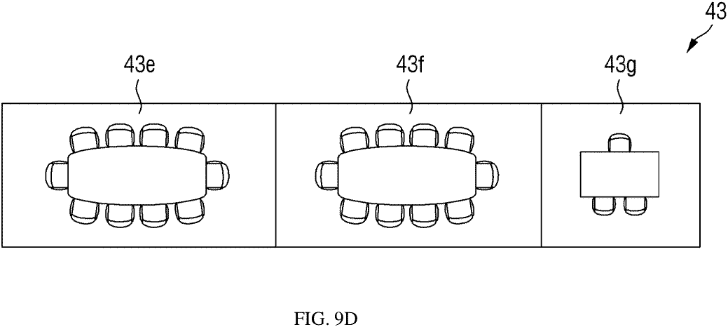

FIGS. 8 to 9D are diagrams of example physical office layouts that may be generated in the method described with reference to FIG. 7. The automatic generation of the layout of an optimization target space 40 specified in step S1110 is illustrated in FIG. 8. The automatically generated layout may be automatically generated by a layout optimization algorithm to include a work area 41, a rest area 42, and a conference room area 43.

FIGS. 9A and 9B are diagrams for explaining the work area 41 that is deformed according to the automatic layout generation. FIG. 9A illustrates a work area 41 that includes intensive work seats 41a and open type work seats 41b. FIG. 9B illustrates the work area 41 in which the ratio of intensive work seats 41c to open type work seats 41d is increased compared to FIG. 9A.

The ratio between the intensive work seat 41c and the open type work seat 41d in FIG. 9B is significantly different from the ratio between the intensive work seat 41a and the open type work seat 41b in FIG. 9A. As described above, this difference may appear when there is a change in the ratio by work type according to the work activity data of employees related to the optimization target space. It should be understood that the ratio of the intensive work type of the related employees increases more when the physical office layout 40 of FIG. 9B is automatically generated than when the physical office layout 40 of FIG. 9A is automatically generated.

Changes in the layout may also be reflected in the conference room area 43. FIG. 9C illustrates a conference room area 43 including one large conference room 43a and three small conference rooms 43b, 43c, and 43d. FIG. 9D illustrates the conference room area 43 including two large conference rooms 43e and 43f and one small conference room 43 g. As described above, information on the meeting personnel may be obtained by analyzing meeting schedule information included in a conference room reservation request or the work tool use data included in the physical office resource utilization data among work activity data of the related employees. Since the demand according to the size of the conference room may be identified according to the meeting personnel, the layout of the conference room area according to the identified demand may be automatically generated.

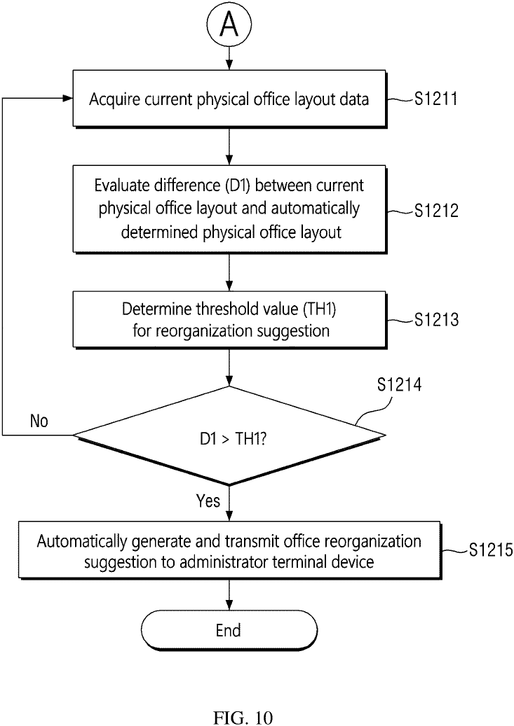

Referring to FIG. 10, a method for automatically generating a physical office reorganization suggestion, according to an embodiment, is described.

In a step S1211, current physical office layout data is acquired. It is desirable that the current physical office layout data includes property data for each resource of each detailed area. For example, information about the ratio of the intensive work seat and the open type work seat of work seats may be confirmed from the current physical office layout data.

In a step S1212, a difference D1 between the physical office layout automatically determined in step S1120 and the current physical office layout data is evaluated. The difference D1 may be computed using a difference in resource ratios for each property included in the physical office layout.

In a step S1213, a threshold value TH1, which is a criterion for whether to suggest reorganization, is determined. The threshold value TH1 may be a predetermined value or a value dynamically determined based on the amount of change in the work activity data of employees. For example, the threshold value TH1 may be dynamically determined in such a way that the threshold value TH1 increases as the fluctuation of the work activity data of the employees increases. This is because it may be not appropriate to change the physical office layout hastily since the higher the fluctuation of the work activity data of the employees, the higher the possibility of situation changes.

When it is determined in a step S1214 that the difference D1 exceeds the threshold value TH1, office reorganization suggestion information may be automatically generated, and, in a step S1215, the office reorganization suggestion information may be transmitted to an administrator terminal device through e-mail and the like.

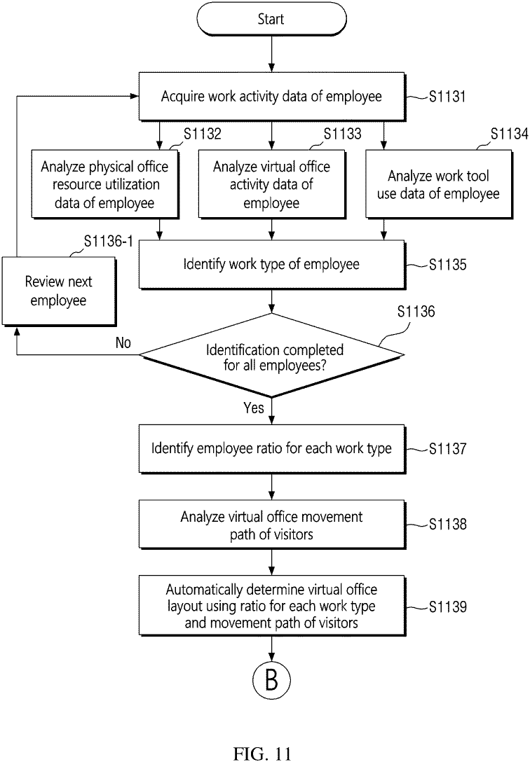

Hereinafter, a method for automatically determining a virtual office layout, according to an embodiment, is described with reference to FIG. 11.

First, operations for identifying the work type of each employee are performed. Unlike the method for automatically determining the physical office layout, in the process of automatically determining the virtual office layout, the work activity data of all employees may be analyzed. Of course, in a situation where a virtual office layout is automatically determined in a section in which access is restricted to a specific group of employees, only work activity data of the specific group of employees is analyzed.

In a step S1131, the work activity data of one or more employees is acquired. Among the work activity data, physical office resource utilization data may be analyzed in a step S1132, virtual office activity data may be analyzed in a step S1133, or work tool use data may be analyzed in a step S1134. Of course, the analysis results of two or more of the physical office resource utilization data, the virtual office activity data, and the work tool use data may be combined. Through the above analysis, in a step S1135, the work type of the related employee may be identified step S1135). In steps S1136 and S1136-1, operations for identifying the work type of the employee are repeated until the identification of the work type is completed for all related employees.

When the work type identification of each related employee is completed in the step S1136, the related employee ratio for each work type may be identified in a step S1137. For example, the ratio of (intensive work type: collaboration type) may be identified.

An optimal ratio for each property of virtual office resources may be determined using the employee ratio for each work type. Accordingly, in a step S11139, the virtual office layout may be automatically determined.

In one embodiment, virtual office activity data is not present when the virtual office layout is automatically determined for the first time. Accordingly, as the work activity data, only the analysis of the physical office resource utilization data (step S1132), and the analysis of the work tool use data (step S1134) may be performed. The quantity of each resource disposed in the virtual office may be determined using the physical office resource utilization data, and the work type for each employee may be identified using the work tool use data (step S1135).

On the other hand, in some embodiments, the virtual office movement path of visitors who have visited the virtual office as outsiders who are not employees is additionally analyzed (step S1138), and the virtual office layout may be automatically determined by analyzing the employee ratio by work type and the virtual office movement path of the visitors together (step S1139). For example, the virtual office layout may be adjusted such that the width of a movement path in which the virtual office movement traffic of the visitors exceeds a reference value is widened.

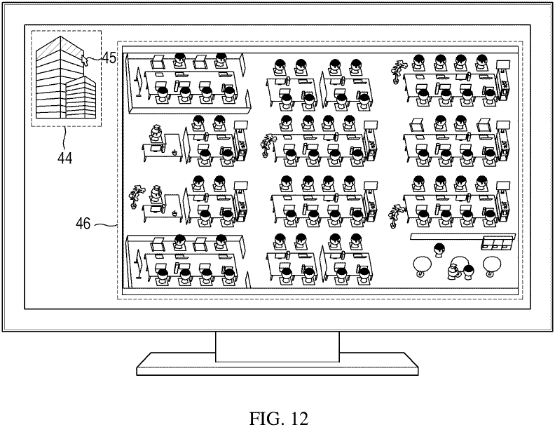

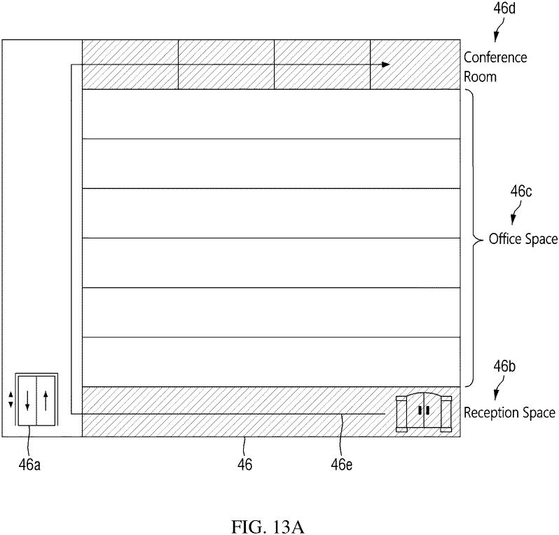

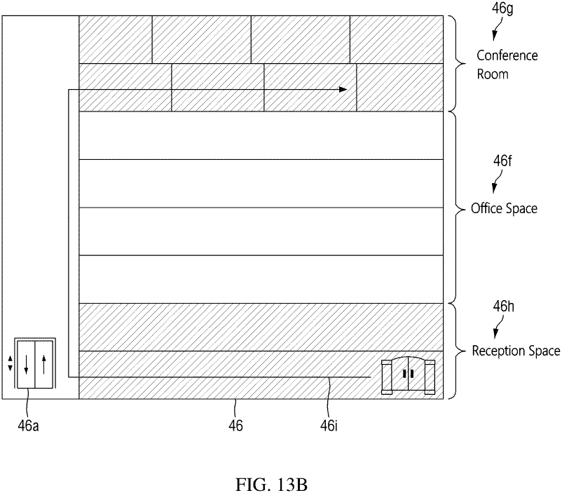

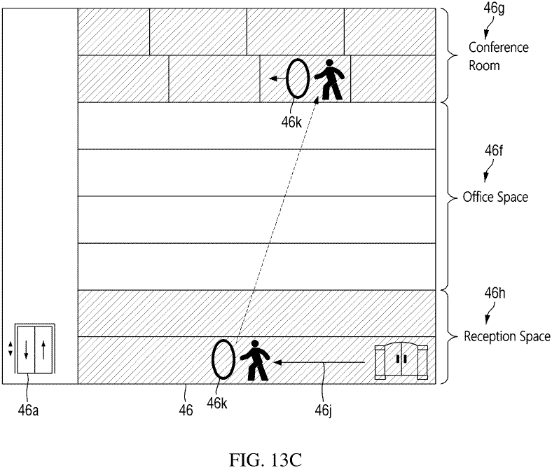

FIGS. 12 to 13C are diagrams of example virtual office layouts that may be generated in the method described with reference to FIG. 11. When a meta work place platform is accessed, a screen as illustrated in FIG. 12 may be displayed. A specific section may be selected on a virtual office map 44. A virtual office layout 46 of the selected section may be displayed. As described above, users such as employees may perform communication with other employees or a work such as video conferences while manipulating their avatars.

FIG. 13A illustrates a first virtual office layout. In some embodiments, outsiders who are not employees may be restricted such that only specific sections of the virtual office are accessed. In FIG. 13A, outsiders may only access a conference room 46d and a reception space 46b, and only employees may enter an office space 46c. In addition, the entrance of the virtual office may be connected to the reception space 46b, and the avatars of users may move to the conference room 46d on the top floor by using an elevator resource 46a.

FIG. 13B illustrates a second virtual office layout. It The virtual office layout of FIG. 13B may be generated, compared to the virtual office layout of FIG. 13A, in a situation where the employee ratio of the intensive work type decreases and the employee ratio of the external collaboration type increases. Accordingly, the ratio of office space in the total section ratio of the virtual office has increased.

FIG. 13C illustrates that a portal 46k for position movement is generated through the virtual office layout update as the movement distance for the avatar of an outsider to move from a reception space to a conference room is long and traffic increases. Due to the generation of the portal 46k, it may be seen that a conference room movement path 46j in FIG. 13C is greatly shortened compared to a conference room movement path 46e of FIG. 13A and a conference room movement path 46i of FIG. 13B.

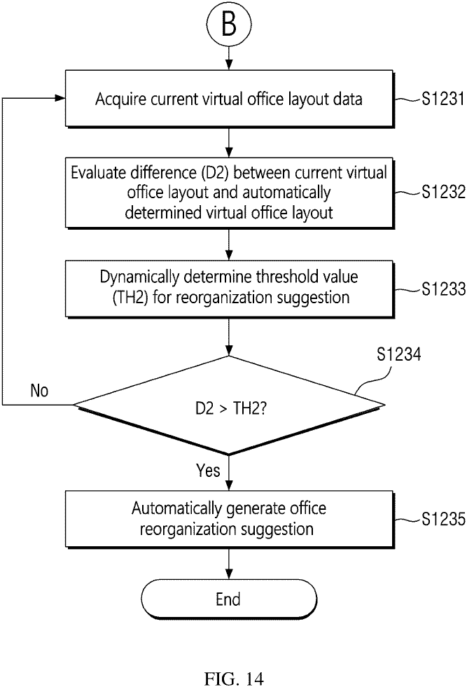

Referring to FIG. 14, a method for automatically generating a virtual office reorganization suggestion, according to an embodiment, is described.

In a step S1231, current virtual office layout data is acquired. It may be desirable that the current virtual office layout data includes property data for each resource of each detailed area. For example, information about the ratio of the intensive work seat and the open type work seat of work seats may be confirmed from the current virtual office layout data.

In a step S1232, a difference D2 between the virtual office layout automatically determined in step S1139 and the current virtual office layout data is evaluated. The difference D2 may be computed using a difference in resource ratios for each property included in the virtual office layout.

In a step S1234, a threshold value TH2 that is a criterion for whether to suggest reorganization is determined. The threshold value TH2 may be a predetermined value, or a value dynamically determined based on the amount of change in the work activity data of employees. For example, the threshold value TH2 may be dynamically determined in such a way that the threshold value TH2 increases as the fluctuation of the work activity data of the employees increases. This is because it may not be appropriate to change the virtual office layout hastily since the higher the fluctuation of the work activity data of the employees, the higher the possibility of situation changes.

When it is determined at a step S1234 that the difference D2 exceeds the threshold value TH2, office reorganization suggestion information may be automatically generated, and, in a step S1235, the office reorganization suggestion information may be transmitted to the administrator terminal device through e-mail and the like.

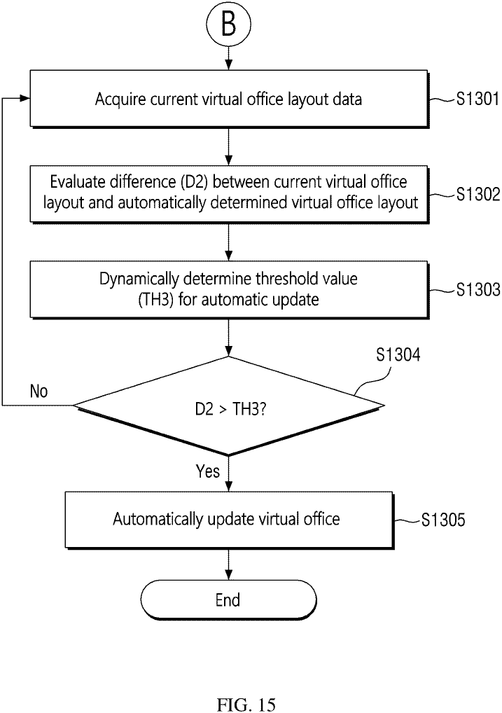

Referring to FIG. 15, a method for automatically updating a virtual office, according to an embodiment, is described.

In a step S1301, current virtual office layout data is acquired. It may be desirable that the current virtual office layout data includes property data for each resource of each detailed area. For example, information about the ratio of the intensive work seat and the open type work seat of work seats may be confirmed from the current virtual office layout data.

In a step S1302, the difference D2 between the virtual office layout automatically determined in the step S1139 and the current virtual office layout data is evaluated. The difference D2 may be computed using a difference in resource ratios for each property included in the virtual office layout.

In a step S1303, a threshold value TH3 that is a criterion for automatic update is dynamically determined. The threshold value TH3 may be a value automatically determined based on the threshold value TH2 described with reference to FIG. 14. For example, TH3 may be determined as a value greater than TH2 by a predetermined value. Since the virtual office is updated only with software updates, when the difference becomes a certain level greater than the reference value TH2 of the reorganization suggestion, it is highly likely that employees experience great inconvenience in using the virtual office. Accordingly, by rapidly and automatically updating the virtual office, employees may use the virtual office comfortably.

When it is determined in a step S1304 that the difference D2 exceeds the threshold value TH3, the virtual office is automatically updated in a step S1305.

In FIG. 15, the automatic upgrade of the virtual office is performed only when the difference D2 exceeds the threshold value TH3, but in some embodiments, the automatic upgrade of the virtual office may be performed periodically.

For example, among the automatically determined layouts, a layout for a public space may be updated with a first cycle, and among the automatically determined layouts, a layout for a personal space may be updated with a second cycle longer than the first cycle.

In some embodiments, among the automatically determined layouts, a layout for a public space may be updated in response to the occurrence of a predetermined event, and among the automatically determined layouts, a layout for a personal space may be updated with a second cycle. The occurrence of the event may be, for example, the occurrence of a congestion situation, such as exceeding the density threshold value of avatars in a public space of a virtual office.

In some embodiments, when a virtual office in a digital twin method is operated, the layout of the physical office corresponding to the virtual office may be adjusted using the work activity data, so that the adjusted layout of the physical office may be automatically determined to be the layout of the virtual office.

In other words, while the layout of the virtual office is partially adjusted based on the layout of the physical office, the adjustment may be based on the work activity data of employees. In this case, while it is based on the digital twin method, a virtual office that is dynamically adjusted by reflecting the work activity data of employees may be operated. Among the virtual offices, an area adjusted based on the work activity data may be limited to a public space.

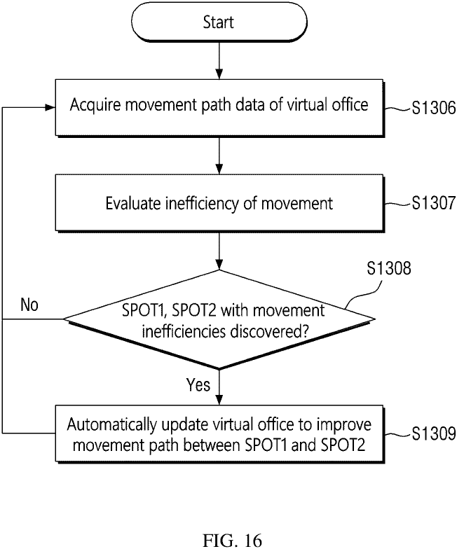

Hereinafter, a method for automatically updating a virtual office, according to an embodiment, is described with reference to FIG. 16.

In a step S1306, movement path data of the virtual office is acquired.

In a step S1307, inefficiency of the movement is evaluated. As described above, the inefficiency of the movement may be evaluated through the number of avatars encountered from the start of the movement to the completion of the movement and the movement distance from the start of the movement to the completion of the movement.

When the first space and the second space with movement inefficiencies are discovered in a step S1308, the virtual office is automatically updated to improve the movement path between the first space and the second space in a step S1309.

For example, any one of generation, removal, and position change of a movement portal from the first space to the second space may be performed. Whether to generate a movement portal from the first space to the second space may be determined using the movement history data of an outsider, and the movement portal may be available only to the avatar of the outsider or the avatar of an employee accompanying the outsider.

In some embodiments, at least one of the first space or the second space may be redisposed such that a distance between the first space and the second space inside the virtual office is adjusted. For example, in the example virtual office illustrated in FIGS. 13A to 13C, the conference room may be redisposed to a floor immediately above the reception space according to the virtual office automatic update.

In some embodiments, the layout of the virtual office may be automatically updated such that the width of the movement path is widened with respect to a crowded movement path between the first space and the second space.

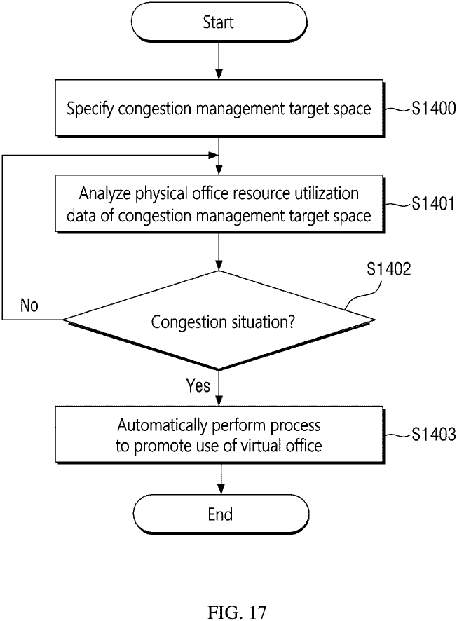

Next, referring to FIG. 17, a method for automatically performing a process to promote the use of a virtual office in the congestion situation of a physical office, according to an embodiment, is described.

In a step S1400, a congestion management target space may be specified. For example, when an employee G logs in, the space in which the office of the department of the employee G is positioned may be the congestion management target space. Of course, in some embodiments, the congestion management target space may not be specified, and the entire physical office may be monitored for a congestion situation.

In a step S1401, analysis of the physical office resource utilization data of the congestion management target space may be performed. Based on the analysis performed in the step S1401, it may be determined whether a congestion situation is present. For example, whether congestion is present may be determined in the step S1402 through analysis in the step S1401 of the reservation system PV (Page View) for resources positioned in the congestion management target space, the number of reservation attempts in the reservation system, and the like.

In an embodiment, the congestion rate of the physical office may be computed using at least some of the number of entered people, the number of people sitting on work seats, the number of people who have reservations for work seats, and the ratio of occupied conference rooms.

As a result of the determination, when it is determined that a physical office congestion situation is present, a process to promote the use of the virtual office may be automatically performed in a step S1403.

The process may include transmitting a physical office congestion situation and a virtual office usage guide to an employee terminal device during a reservation process for a physical office resource. Further, the process may include determining whether to approve the reservation by reflecting the performance of the virtual office during the reservation process for the physical office resource. In addition, the above process may include a process of transmitting the physical office congestion situation and the virtual office usage guide to the terminal device of the target employee who occupies or has reserved a physical office resource that may be migrated to a virtual office, among the employees selected by using the virtual office use history and the occupancy of the physical office resource.

An example physical office resource that may be migrated to the virtual office is a conference room or a work seat. In an embodiment, since the work seat is a minimum basic resource for an employee to settle in the physical office, the process to promote the use of work seats in the virtual office may be automatically performed only when the terminal of the employee is at least a predetermined distance away from the physical office.

In some embodiments, the above process may include a process of transmitting the physical office congestion situation and the virtual office usage guide to the terminal device of the target employee for whom the productivity of the virtual office resource corresponding to the currently occupied physical office resource is evaluated to be higher than the productivity of the physical office resource currently occupied or being requested for reservation, among the target employees.

For productivity evaluation according to the occupation of the physical office resource, occupation time of the physical office resource, communication traffic generated while the physical office resource is occupied, quality of a product generated while the physical office resource is occupied, and the like may be evaluated. The product generated while the physical office resource is occupied may be identified by analyzing work tool use data during the occupation time.

For example, the shorter the occupation time of the physical office resource, the greater the communication traffic generated while the physical office resource is occupied, and the higher the quality of the product generated while the physical office resource is occupied, the higher the productivity may be evaluated. In addition, the number of physical office reservation extensions may reduce the above evaluated productivity. Communication traffic while the physical office resource is occupied may be automatically generated by a built-in microphone with a speech-to-text (STT) function installed in the physical office resource.

Productivity evaluation according to the occupation of virtual office resources may also be evaluated in a manner similar to that of physical office resources. In order to evaluate the productivity of the virtual office resource, the occupation time of the virtual office resource, communication traffic generated while the virtual office resource is occupied, quality of a product generated while the virtual office resource is occupied, and the like may be evaluated.

For example, when the physical office resource currently being requested for reservation is a conference room, the productivity may be evaluated based on at least one of occupation time, communication traffic generated during occupation, quality of a product generated during occupation, or a reservation time extension history of a conference room.

The process may include automatically performing an update to extend a first resource of the virtual office corresponding to a first resource of the physical office determined to be congested.

Various embodiments of the present disclosure and effects according to the embodiments have been described with reference to FIGS. 1 to 17. Effects according to the technical spirit of the present disclosure are not limited to the effects mentioned above, and other effects not mentioned should be clearly understood by those having ordinary skill in the art from the description below. The technical spirit of the present disclosure described may be implemented as computer readable codes on a computer readable medium. A computer program recorded on the computer-readable recording medium may be transmitted to another computing apparatus through a network such as the Internet, be installed in the other computing apparatus, and thus be used in the other computing apparatus.

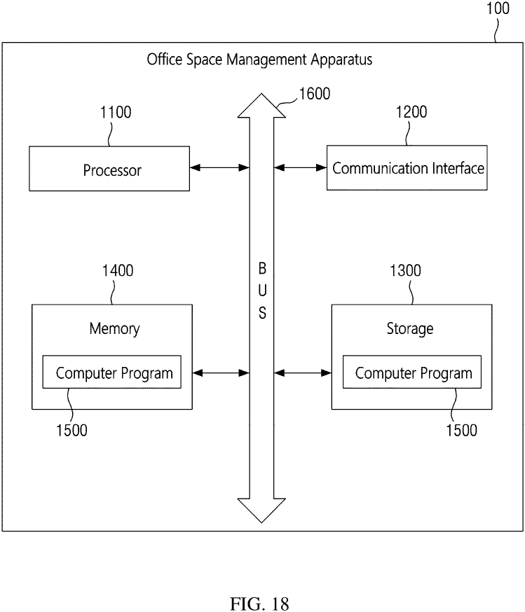

FIG. 18 is a hardware configuration diagram of the office space management apparatus 100, according to some embodiments of the present disclosure. The office space management apparatus 100 may include one or more processors 1100, a system bus 1600, a communication interface 1200, a memory 1400 that loads a computer program 1500 executed by the processor 1100, and a storage 1300 that stores the computer program 1500.

The office space management apparatus 100 may be connected to the work activity data archive 14, a service server of the smart workplace platform 11, a service server of the smart work tool 12, and a service server of the meta workplace platform 13 through the communication interface 1200.

The processor 1100 controls the overall operation of each configuration of the office space management apparatus 100. The processor 1100 may perform an operation for at least one application or program that executes a method and operation according to various embodiments of the present disclosure. The memory 1400 stores various data, commands, and/or information. The memory 1400 may load one or more computer programs 1500 from the storage 1300 to execute the methods and operations according to various embodiments of the present disclosure. The bus 1600 provides a communication function between components of the office space management apparatus 100. The communication interface 1200 supports internet communication of the office space management apparatus 100. The storage 1300 may non-temporarily store one or more computer programs 1500. The computer program 1500 may include one or more instructions to implement the methods and operations according to various embodiments of the present disclosure. When the computer program 1500 is loaded into the memory 1400, the processor 1100 may execute the one or more instructions to perform the methods and operations according to various embodiments of the present disclosure.

The computer program 1500 may include instructions that perform the methods and operations according to various embodiments of the present disclosure. For example, the computer program 1500 may include at least some of office reorganization suggestion instructions, virtual office layout management instructions, and virtual office use promotion instructions. In an embodiment, the office space management apparatus 100 may be configured by an administrator to operate with at least some of an office reorganization suggestion function, a virtual office layout management function, and a virtual office use promotion function in an activated state.

The office reorganization suggestion instructions may include instructions that determine an optimal office layout by using the work activity data, instructions that evaluate a difference between the optimal office layout and a current office layout, instructions that automatically generate an office reorganization suggestion based on the evaluated difference, and instructions that transmit the office reorganization suggestion to a user terminal through the network interface.

The virtual office layout management instructions may include instructions that automatically determine a layout of a virtual office by using the work activity data and instructions that perform an automatic update on the layout of the virtual office by using movement path data in the virtual office.

The virtual office use promotion instructions may include instructions that determine a physical office congestion situation by using the physical office resource utilization data and instructions that automatically perform a process to promote the use of the virtual office in the physical office congestion situation.

Embodiments of the present disclosure have been described above with reference to FIGS. 1 through 18, but it should be noted that the effects of the present disclosure are not limited to those described above, and other effects of the present disclosure should be apparent from the following description.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those having ordinary skill in the art should appreciate that many variations and modifications can be made to the embodiments without substantially departing from the principles of the present disclosure. Therefore, the disclosed embodiments of the present disclosure are used in a generic and descriptive sense only and not for purposes of limitation.

What is claimed is:

1. A computer-implemented method for managing space of a physical office and a virtual office, the method comprising:
acquiring work activity data of one or more employees;
determining an optimal office layout using the work activity data;
evaluating a difference between the optimal office layout and a current office layout; and
generating an office reorganization suggestion based on the evaluated difference.

2. The method of claim 1, wherein determining the optimal office layout includes:
determining a work type of each employee, among the one or more employees, using the work activity data, and
determining an optimal ratio for each property of office resources using a number of employees for each work type.

3. The method of claim 1, wherein generating the office reorganization suggestion includes determining whether to generate the office reorganization suggestion using a magnitude of the evaluated difference and fluctuation of the work activity data.

4. The method of claim 1, wherein the optimal office layout and the current office layout are for the virtual office.

5. A computer-implemented method for managing space of a physical office and a virtual office, the method comprising:
acquiring work activity data of one or more employees; and
determining an optimal layout of a virtual office using the work activity data.

6. The method of claim 5, wherein the work activity data comprises physical office resource utilization data and work tool use data.

7. The method of claim 6, wherein determining the layout of the virtual office includes:
determining a quantity of each resource disposed in the virtual office using the physical office resource utilization data, and
determining properties of each resource disposed in the virtual office using the work tool use data.

8. The method of claim 7, wherein determining the properties of each resource disposed in the virtual office includes:
determining a work type for each employee, among the one or more employees, using the work tool use data of each employee,
aggregating a number of employees for each work type, and
determining the properties of each resource using a result of the aggregation.

9. The method of claim 8, wherein determining the properties of each resource using the result of the aggregation includes determining an object to be added-on to each resource using the result of the aggregation.

10. The method of claim 6, wherein the work activity data further comprises activity data of the one or more employees in the virtual office.

11. The method of claim 5, wherein determining the layout of the virtual office comprises updating a current virtual office layout with the determined layout.

12. The method of claim 11, wherein updating the current virtual office layout with the determined layout includes:
updating a layout for a public space among the determined layouts with a first cycle; and
updating a layout for a personal space among the determined layouts with a second cycle longer than the first cycle.

13. The method of claim 11, wherein updating the current virtual office layout with the determined layout includes:
updating a layout for a public space among the determined layouts in response to occurrence of a predetermined event; and
updating a layout for a personal space among the determined layouts with a second cycle.

14. The method of claim 5, wherein determining the layout of the virtual office includes:
acquiring a layout of a physical office corresponding to the virtual office; and
adjusting the acquired layout of the physical office using the work activity data to determine the adjusted layout of the physical office as the layout of the virtual office.

15. A computer-implemented method for managing space of a physical office and a virtual office, the method comprising:
acquiring movement path data in the virtual office; and
performing an update on a layout of the virtual office using the movement path data.

16. The method of claim 15, wherein performing the update on the layout of the virtual office includes performing an update on a movement means from a first space to a second space inside the virtual office using the movement path data.

17. The method of claim 16, wherein performing the update on the movement means from the first space to the second space inside the virtual office includes performing any one of generation, removal, and position change on a movement portal from the first space to the second space.

18. The method of claim 17, wherein:
acquiring the movement path data in the virtual office includes acquiring movement path data of an outsider in the virtual office,
performing any one of generation, removal, and position change on the movement portal from the first space to the second space includes determining whether to generate a movement portal from the first space to the second space by using the movement path data of an outsider, and
the movement portal is available only to an avatar of an outsider or an avatar of an employee accompanying the outsider.

19. The method of claim 15, wherein performing the update on the layout of the virtual office includes redisposing at least one of the first space or the second space such that a distance between the first space and the second space inside the virtual office is adjusted using the movement path data.

20. The method of claim 15, wherein performing the update on the layout of the virtual office includes adjusting graphic properties of a movement passage to widen the movement passage from the first space to the second space inside the virtual office by using the movement path data.

21. A computer-implemented method for managing space of a physical office and a virtual office, the method comprising:
acquiring physical office resource utilization data;
determining whether the physical office is congested by analyzing the physical office resource utilization data; and
when it is determined that the physical office is congested, performing a process to promote use of the virtual office.

22. The method of claim 21, wherein performing the process to promote use of the virtual office includes transmitting a physical office congestion situation indication and a virtual office usage guide to an employee terminal device during a reservation process for a physical office resource.

23. The method of claim 21, wherein performing the process to promote use of the virtual office includes determining whether to approve a reservation by reflecting performance of the virtual office during a reservation process for a physical office resource.

24. The method of claim 21, wherein performing the process to promote use of the virtual office includes transmitting a physical office congestion situation indication and a virtual office usage guide to a terminal device of a target employee who occupies or has reserved a physical office resource that can be migrated to the virtual office, among employees selected by using virtual office use history and occupancy of the physical office resource.

25. The method of claim 24, wherein performing the process to promote use of the virtual office includes transmitting a physical office congestion situation indication and a virtual office usage guide to a terminal device of a target employee for whom productivity of a virtual office resource corresponding to a currently occupied physical office resource is evaluated to be higher than productivity of a physical office resource currently occupied or being requested for reservation, among the target employees.

26. The method of claim 25, wherein:
the physical office resource that can be migrated to the virtual office is a conference room, and
the productivity is evaluated based on at least one of occupation time, communication traffic generated during occupation, quality of a product generated during occupation, or reservation time extension history of the conference room.

27. The method of claim 21, wherein the performing process to promote use of the virtual office includes performing an update to extend a first resource of the virtual office corresponding to a first resource of the physical office determined to be congested.
